(19) United States
(12) Patent Application Publication
(10) Pub. No.: US 2017/0315924 A1
(43) Pub. Date: Nov. 2, 2017

(54) Dynamically Sizing a Hierarchical Tree Based on Activity

(71) Applicant: NetApp, Inc., Sunnyvale, CA (US)

(72) Inventors: Joseph Blount, Wichita, KS (US); William P. Delaney, Wichita, KS (US); Charles Binford, Wichita, KS (US); Joseph Moore, Wichita, KS (US); Randolph Sterns, Boulder, CO (US)

(21) Appl. No.: 15/143,135

(22) Filed: Apr. 29, 2016

(51) Int. Cl. G06F 12/10

(52) U.S. Cl. CPC G06F 12/10

(57) ABSTRACT

A method, a computing device, and a non-transitory machine-readable medium for allocating memory to data structures that map a first address space to a second is provided. In some embodiments, the method includes identifying, by a storage system, a pool of memory resources to allocate among a plurality of address maps. Each of the plurality of address maps includes at least one entry that maps an address in a first address space to an address in a second address space. An activity metric is determined for each of the plurality of address maps, and a portion of the pool of memory is allocated to each of the plurality of address maps based on the respective activity metric. The allocating of the portion of the memory pool to a first map may be performed in response to a merge operation being performed on the first map.

### TECHNICAL FIELD

The present description relates to a data storage architecture, and more specifically, to a technique for managing an address map used to translate memory addresses from one address space to another within the data storage architecture.

### BACKGROUND

Networks and distributed storage allow data and storage space to be shared between devices located anywhere a connection is available. These implementations may range from a single machine offering a shared drive over a home network to an enterprise-class cloud storage array with multiple copies of data distributed throughout the world. Larger implementations may incorporate Network Attached Storage (NAS) devices, Storage Area Network (SAN) devices, and other configurations of storage elements and controllers in order to provide data and manage its flow. Improvements in distributed storage have given rise to a cycle where applications demand increasing amounts of data delivered with reduced latency, greater reliability, and greater throughput. Hand-in-hand with this trend, system administrators have taken advantage of falling storage prices to add capacity wherever possible.

To provide this capacity, increasing numbers of storage elements have been added to increasingly complex storage systems. To accommodate this, the storage systems utilize one or more layers of indirection that allow connected systems to access data without concern for how it is distributed among the storage devices. The connected systems issue transactions directed to a virtual address space that appears to be a single, contiguous device regardless of how many storage devices are incorporated into the virtual address space. It is left to the storage system to translate the virtual addresses into physical addresses and provide them to the storage devices. RAID (Redundant Array of Independent/Inexpensive Disks) is one example of a technique for grouping storage devices into a virtual address space, although there are many others. In these applications and others, indirection hides the underlying complexity from the connected systems and their applications.

RAID and other indirection techniques maintain one or more tables that map or correlate virtual addresses to physical addresses or other virtual addresses. However, as the sizes of the address spaces grow, the tasks of managing and searching the tables may become a bottleneck. The overhead associated with these tasks is non-trivial, and many implementations require considerable processing resources to manage the mapping and require considerable memory to store it. Accordingly, while conventional indirection maps and mapping techniques have been generally adequate, an improved system and technique for mapping addresses to other addresses has the potential to dramatically improve storage system performance.

### BRIEF DESCRIPTION OF THE DRAWINGS

The present disclosure is best understood from the following detailed description when read with the accompanying figures.

FIG. 1 is a schematic diagram of a data storage architecture according to aspects of the present disclosure.

FIG. 2 is a memory diagram of an address map according to aspects of the present disclosure.

FIG. 3 is a flow diagram of a method of managing the address map according to aspects of the present disclosure.

FIGS. 4-7 are memory diagrams of an address map at various stages of the method according to aspects of the present disclosure

FIG. 8 is a schematic diagram of a data storage architecture according to aspects of the present disclosure.

FIG. 9 is a flow diagram of a method of allocating resources among address maps according to aspects of the present disclosure.

FIG. 10 is a diagram of a journal according to aspects of the present disclosure.

### DETAILED DESCRIPTION

All examples and illustrative references are non-limiting and should not be used to limit the claims to specific implementations and embodiments described herein and their equivalents. For simplicity, reference numbers may be repeated between various examples. This repetition is for clarity only and does not dictate a relationship between the respective embodiments unless otherwise noted. Finally, in view of this disclosure, particular features described in relation to one aspect or embodiment may be applied to other disclosed aspects or embodiments of the disclosure, even though not specifically shown in the drawings or described in the text.

Various embodiments include systems, methods, and machine-readable media for improved mapping of addresses and for allocating resources such as memory space among address maps based on a workload. In an exemplary embodiment, a storage system maintains one or more address maps for translating addresses in a first address space into addresses in a second address space. The address maps are structured as hierarchical trees with multiple levels (L0, L1, L2, etc.). However, not all address spaces will experience the same workload, and so the storage system monitors and logs transaction statistics associated with each address map to detect “hot spots” that experience relatively more transaction activity. Address maps that correspond to hot spots may be allocated more memory than other address maps. In some examples where the memory is fungible, the storage system allocates more memory to the hotter address maps. In other examples where the memory includes discrete memory devices of various sizes, larger devices are assigned to the hotter address maps and smaller devices are assigned to the cooler address maps. In order to free up additional memory, in some examples, the storage system redirects memory used for buffering or other purposes to allocate to the hottest address maps.

Rather than interrupt the normal function of the address maps, the memory resources may be adjusted during a merge process where data is copied out of one level of the hierarchical tree and merged with that of a lower level. Because the merge process may create a new instance of the level being merged, the storage system can apply a new memory limit to the new instance or create the new instance in a designated memory device with minimal overhead.

In this way, the storage system is able to optimize the allocation of memory across the address maps. Memory resources can be allocated where they will provide the greatest performance benefit, and reallocating memory during the merge process reduces the overhead associated with the changes. Accordingly, the present technique provides significant, meaningful, real-world improvements to conventional address map management. The importance of these improvements will only grow as more storage devices are added and address spaces continue to expand. Of course, these advantages are merely exemplary, and no particular advantage is required for any particular embodiment.

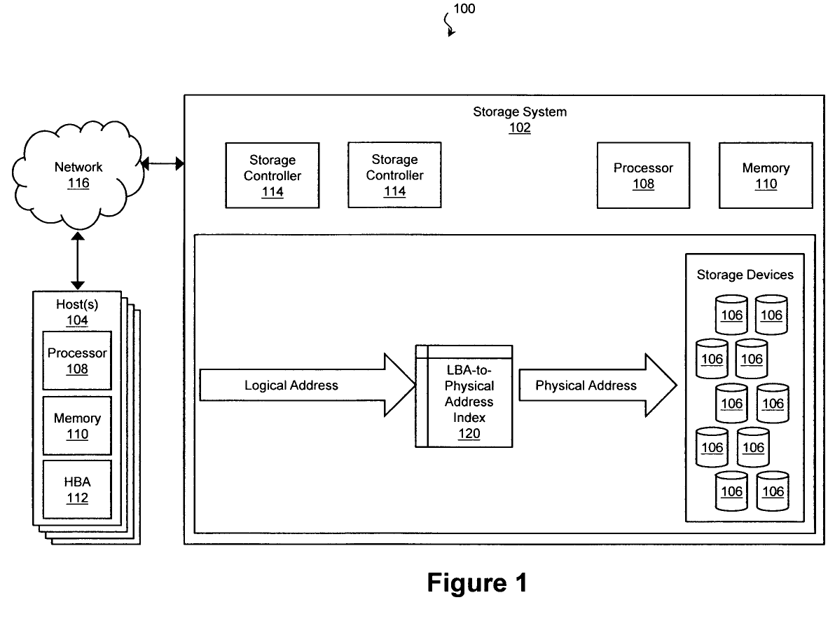

FIG. 1 is a schematic diagram of a data storage architecture 100 according to aspects of the present disclosure. The data storage architecture 100 includes a storage system 102 that processes data transactions on behalf of other computing systems including one or more hosts 104. The storage system 102 is only one example of a computing system that may perform data storage and indirection (i.e., virtualization). It is understood that present technique may be performed by any computing system (e.g., a host 104 or third-party system) operable to read and/or write data from any suitable storage device 106.

The exemplary storage system 102 receives data transactions (e.g., requests to read and/or write data) from the hosts 104 and takes an action such as reading, writing, or otherwise accessing the requested data so that the storage devices 106 of the storage system 102 appear to be directly connected (local) to the hosts 104. This allows an application running on a host 104 to issue transactions directed to the storage devices 106 of the storage system 102 and thereby access data on the storage system 102 as easily as it can access data on the storage devices 106 of the host 104. It is understood that for clarity and ease of explanation, only a single storage system 102 and a single host 104 are illustrated, although the data storage architecture 100 may include any number of hosts 104 in communication with any number of storage systems 102.

Furthermore, while the storage system 102 and the hosts 104 are referred to as singular entities, a storage system 102 or host 104 may include any number of computing devices and may range from a single computing system to a system cluster of any size. Accordingly, each storage system 102 and host 104 includes at least one computing system, which in turn may include a processor 108 operable to perform various computing instructions, such as a microcontroller, a central processing unit (CPU), or any other computer processing device. The computing system may also include a memory device 110 such as random access memory (RAM); a non-transitory machine-readable storage medium such as a magnetic hard disk drive (HDD), a solid-state drive (SSD), or an optical memory (e.g., CD-ROM, DVD, BD); a video controller such as a graphics processing unit (GPU); a communication interface such as an Ethernet interface, a Wi-Fi (IEEE 802.11 or other suitable standard) interface, or any other suitable wired or wireless communication interface; and/or a user I/O interface coupled to one or more user I/O devices such as a keyboard, mouse, pointing device, or touchscreen.

With respect to the hosts 104, a host 104 includes any computing resource that is operable to exchange data with a storage system 102 by providing (initiating) data transactions to the storage system 102. In an exemplary embodiment, a host 104 includes a host bus adapter (HBA) 112 in communication with a storage controller 114 of the storage system 102. The HBA 112 provides an interface for communicating with the storage controller 114, and in that regard, may conform to any suitable hardware and/or software protocol. In various embodiments, the HBAs 112 include Serial Attached SCSI (SAS), iSCSI, InfiniBand, Fibre Channel, and/or Fibre Channel over Ethernet (FCoE) bus adapters. Other suitable protocols include SATA, eSATA, PATA, USB, and FireWire. In many embodiments, the host HBAs 112 are coupled to the storage system 102 via a network 116, which may include any number of wired and/or wireless networks such as a Local Area Network (LAN), an Ethernet subnet, a PCI or PCIe subnet, a switched PCIe subnet, a Wide Area Network (WAN), a Metropolitan Area Network (MAN), the Internet, or the like. To interact with (e.g., read, write, modify, etc.) remote data, the HBA 112 of a host 104 sends one or more data transactions to the storage system 102 via the network 116. Data transactions may contain fields that encode a command, data (i.e., information read or written by an application), metadata (i.e., information used by a storage system to store, retrieve, or otherwise manipulate the data such as a physical address, a logical address, a current location, data attributes, etc.), and/or any other relevant information.

With respect to the storage system 102, the exemplary storage system 102 contains one or more storage controllers 114 that receive the transactions from the host(s) 104 and that perform the data transaction using the storage devices 106. However, a host 104 and the storage devices 106 may use different addresses to refer to the same data. For example, the host 104 may refer to a virtual address (e.g., a Logical Block Address, aka LBA) when it issues a transaction. Upon receiving the transaction, the storage system 102 may convert the virtual address into a physical address, which it provides to the storage devices 106. In other examples, the host 104 may issue data transactions directed to virtual addresses that the storage system 102 converts into other virtual or physical addresses.

In fact, the storage system 102 may convert addresses to other types of addresses several times before determining a final address to provide to the storage devices 106. In the illustrated embodiments, the storage controllers 114 or other elements of the storage system 102 convert LBAs contained in the hosts' data transactions to physical block address, which is then provided to the storage devices 106.

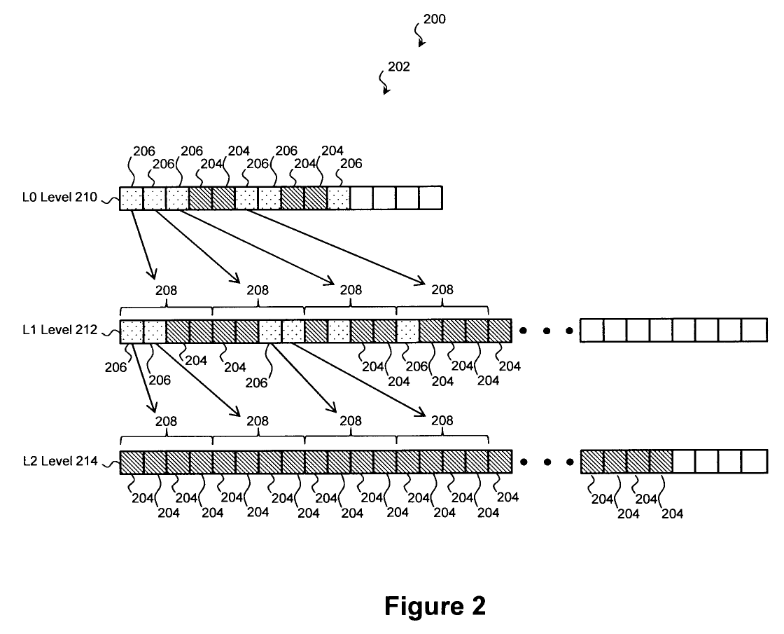

As described above, a storage controller 114 or other element of the storage system 102 utilizes an index such as an LBA-to-Physical Address index 120 in order to convert addresses in a first address space into addresses in a second address space. FIG. 2 is a memory diagram 200 of an address map 202 according to aspects of the present disclosure. The address map 202 is suitable for use in the LBA-to-Physical Address index 120, or any other address-mapping index.

The address map 202 includes a number of entries arranged in a memory structure, and may be maintained in any suitable structure including a linked list, a tree, a table such as a hash table, an associative array, a state table, a flat file, a relational database, and/or other memory structure. One particular data structure that is well-suited for use as an address map 202 is a hierarchical tree. A hierarchical tree contains leaf nodes that map addresses and index nodes that point to other nodes. These nodes are arranged in hierarchical levels structured for searching.

In the illustrated embodiments, the leaf nodes are data range descriptors 204 that each map an address or address range in a first address space to an address or address range in a second address space. The data range descriptors 204 may take any suitable form, examples of which are described below.

The other types of nodes, index nodes 206 may be found in any of the upper levels of the hierarchical tree and refer to the next lower level. To that end, each index node 206 may map an address or address range in the first address space to a corresponding index page 208, a region of the next lower level of any arbitrary size and that contains any arbitrary number of index nodes 206 and/or data range descriptors 204.

In the illustrated embodiments, the address map 202 is a three-level hierarchical tree although it is understood that the address map 202 may have any suitable number of levels of hierarchy. The first exemplary level, referred to as the L0 level 210, has the highest priority in that it is searched first and data range descriptors 204 in the L0 level 210 supersede data in other levels. It is noted that when data range descriptors 204 are added or modified, it is not necessary to immediately delete an old or existing data range descriptor 204. Instead, data range descriptors 204 in a particular level of the hierarchy supersede those in any lower levels while being superseded by those in any higher levels of the hierarchy. It should be further noted that superseded data range descriptors 204 represent trapped capacity within the address map 202 that may be freed by a merge operation described below.

The second exemplary level, the L1 level 212, is an intermediate hierarchical level in that it is neither the first level nor the last. Although only one intermediate hierarchical level is shown, in various embodiments, the address map 202 includes any numbers of intermediate levels. As with the L0 level 210, intermediate level(s) may contain any combination of data range descriptors 204 and index nodes 206. Data range descriptors 204 in an intermediate level supersede those in lower levels (e.g., the L2 level 214) while being superseded by those in upper levels of the hierarchy (e.g., the L0 level 210).

The L2 level 214 is the third illustrated level, and is representative of a lowest hierarchical level. Because the L2 level 214 does not have a next lower level for the index nodes 206 to refer to, it includes only data range descriptors 204. In a typical example, the L2 level 214 has sufficient capacity to store enough data range descriptors 204 to map each address in the first address space to a corresponding address in the second address space. However, because some address in the first address space may not have been accessed yet, at times, the L2 level 214 may contain significantly fewer data range descriptors 204 than its capacity.

In order to search the address map 202 to translate an address in the first address space, the storage controller 114 or other computing entity traverses the tree through the index nodes 206 until a data range descriptor 204 is identified that corresponds to the address in the first address space. To improve search performance, the data range descriptors 204 and the index nodes 206 may be sorted according to their corresponding addresses in the first address space. This type of hierarchical tree provides good search performance without onerous penalties for adding or removing entries.

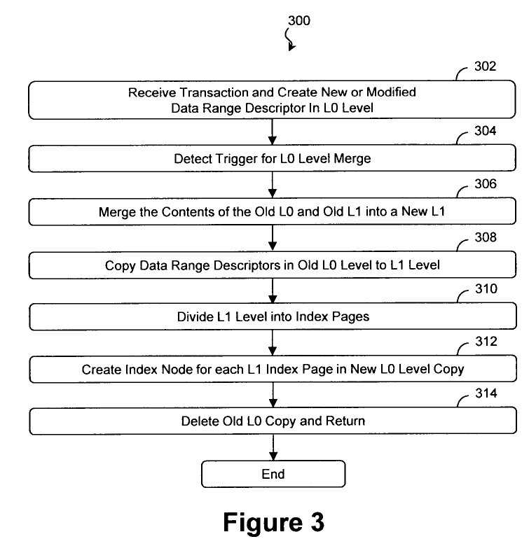

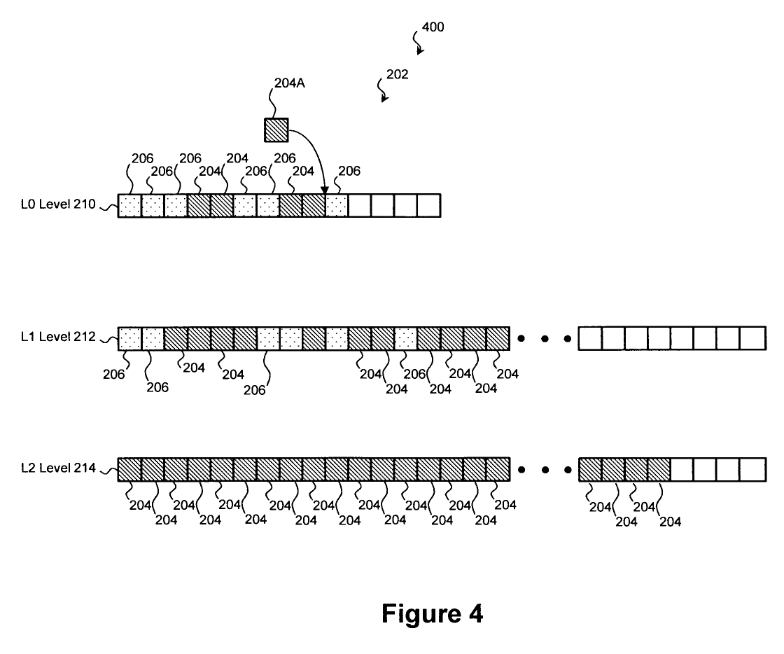

A technique for managing such an address map 202 is described with reference to FIGS. 3-7. In that regard, FIG. 3 is a flow diagram of a method 300 of managing the address map 202 according to aspects of the present disclosure. It is understood that additional steps can be provided before, during, and after the steps of method 300, and that some of the steps described can be replaced or eliminated for other embodiments of the method. FIGS. 4-7 are memory diagrams 400 of an address map 202 at various stages of the method 300 according to aspects of the present disclosure.

Referring to block 302 of FIG. 3 and to FIG. 4, when a transaction is received that creates, replaces, or modifies a data range descriptor 204, the storage controller 114 or other computing element writes a new data range descriptor 204A to the L0 level 210. As the index nodes 206 and data range descriptors 204 in the L0 level 210 may be sorted or otherwise searched according to their respective addresses in the first address space, the new data range descriptor 204A may be inserted a location selected to preserve this ordering of nodes. It is noted that writing a data range descriptor 204 to the L0 level 210 may supersede a data range descriptor in the L1 level 212 or in the L2 level 214. The process of block 302 may be repeated multiple times.

Referring to block 304 of FIG. 3, the storage controller 114 or other computing element detects a trigger that initiates a merge process on the L0 level 210. In that regard, any suitable trigger may be used. In many examples, the trigger is based at least in part on the percentage of the L0 level 210 that is used. Additionally or in the alternative, the trigger may be based at least in part on: a percentage of another level that is used, an interval of time, a total count of data transactions received or processed, a system event such as a change in the storage devices 106, and/or any other suitable triggering event. Another trigger may include the map no longer deserving its large L0 level. For example, at time t1, an address map was hot and was allocated a large L0 level. At a later time t2, the address map had become cold, and other maps were more deserving of its L0 space. Continuing with the example, the storage controller 114 may detect this condition to trigger a merge, at which point the address map will receive a smaller L0 buffer more suitable for its activity after time t2.

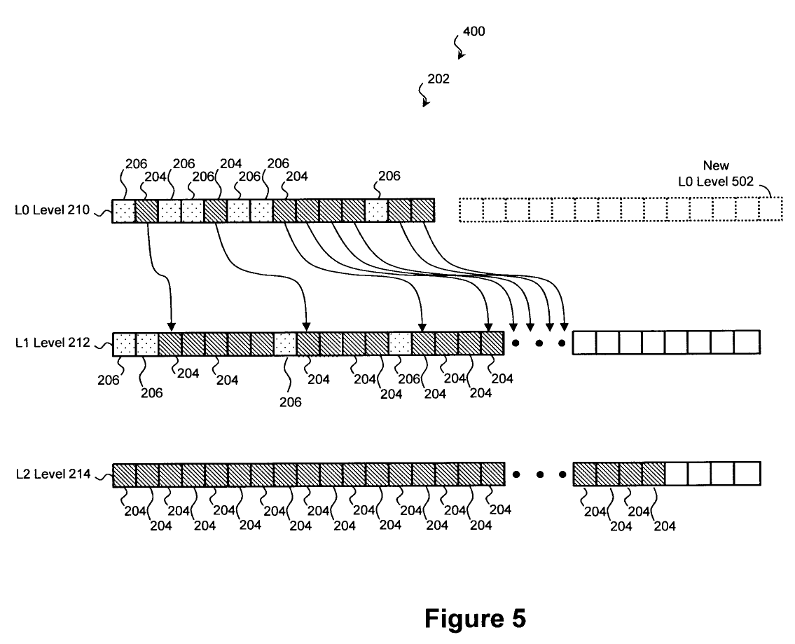

Referring to block 306 of FIG. 3 and to FIG. 5, upon detecting a trigger, the storage controller 114 or other computing element initiates the merge process by freezing the existing L0 level 210 and creating a placeholder in memory for a new instance 502 of the L0 level. Referring to block 308 of FIG. 3, the storage controller 114 or other computing element copies the data range descriptors 204 in the existing L0 level 210 into the next lowest level (the L1 level 212), thereby creating a new L1 level 212. The copied data range descriptors 204 may overwrite superseded data range descriptors 204 already in the L1 level 212. In so doing, this process “frees” the capacity of the address map 202 trapped in the superseded data range descriptors 204.

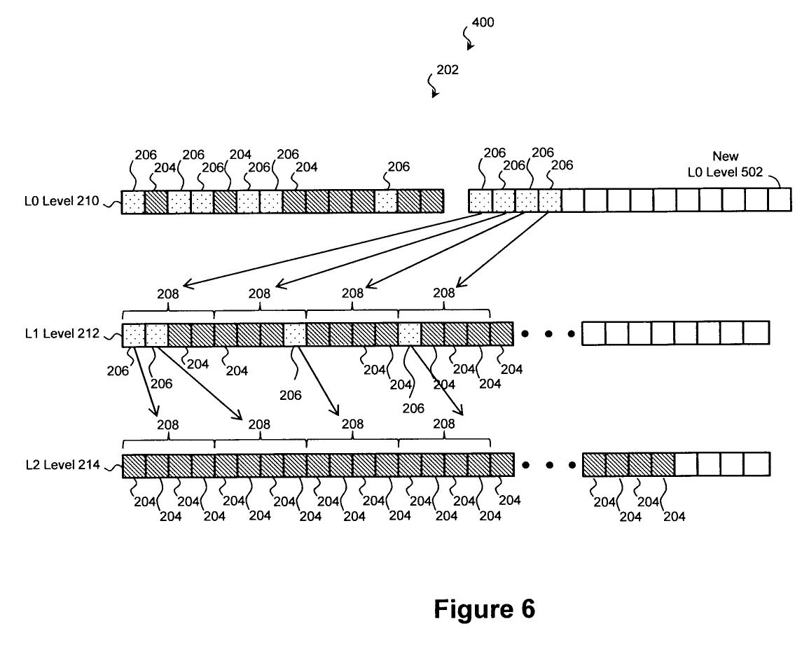

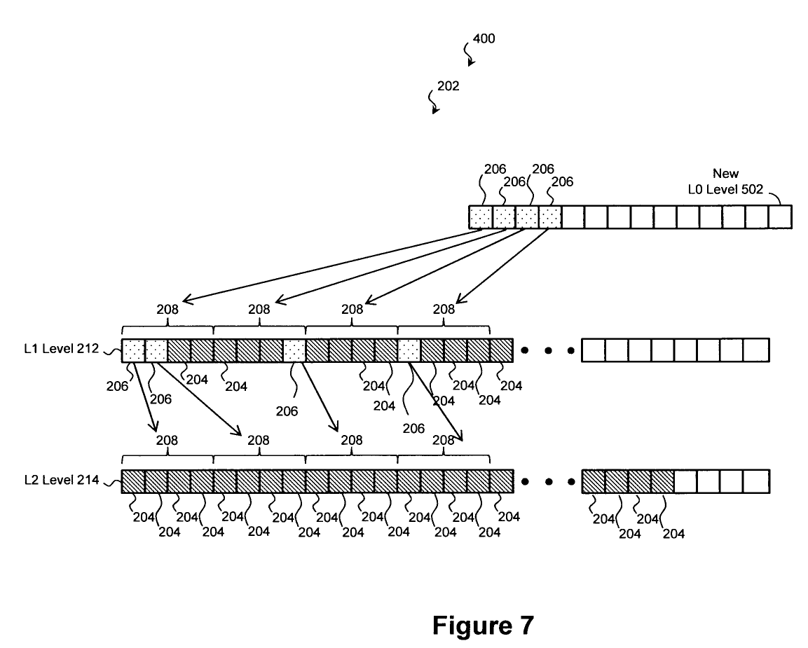

Referring to block 310 of FIG. 3, the storage controller 114 or other computing element divides the next lowest level (the L1 level 212) into index pages 208. In many embodiments, the storage controller 114 merely retains the existing index pages 208 already defined in the lower level. Referring to block 312 of FIG. 3 and to FIG. 6, the storage controller 114 or other computing element creates an index node 206 for each index page 208 in the next lowest level and writes them into the new instance 502 of the L0 level. Referring to block 314 of FIG. 3 and to FIG. 7, the storage controller 114 or other computing element completes the merge process by deleting the old L0 level 210 and returning to block 302. When new data range descriptors 204 are written in block 302, they are written to the new instance 502 of the L0 level 210.

It will be recognized that the merge process of blocks 306 through 314 may also be performed on any of the intermediate hierarchical levels, such as the L1 level 212, to compact the levels and free additional trapped capacity.

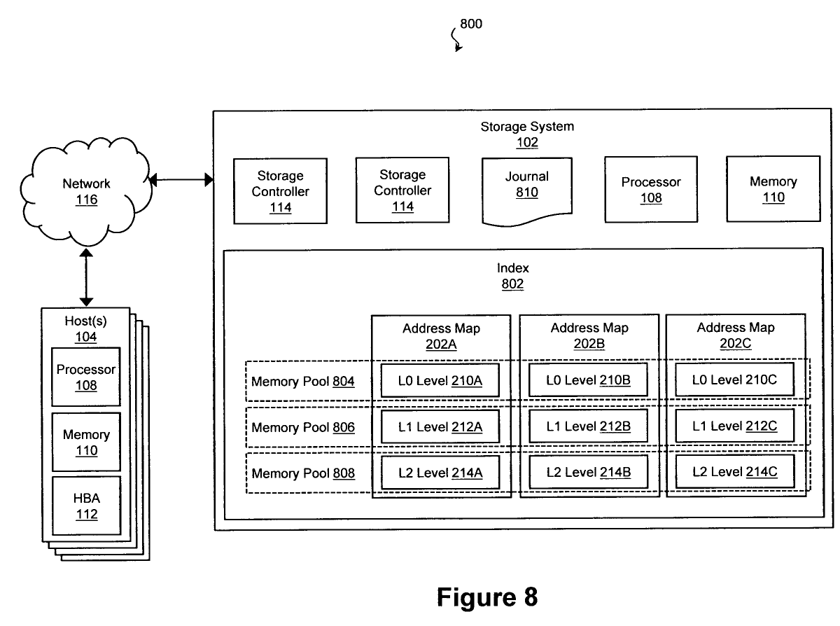

It is been determined that the amount of memory allocated to each level has a considerable effect on the performance of the address map 202, particularly when a system has more than one address map 202 that shares a common pool of memory. In general, a larger L0 level 210 reduces the amount of write traffic to the L1 level 212 and/or the L2 level 214 caused by the average transaction. This overhead may be referred to as a write tax. However, a larger L0 level 210 requires more memory for itself and may also trap more invalid entries in the lower level. A technique for balancing these competing demands is described with reference to FIGS. 8-10.

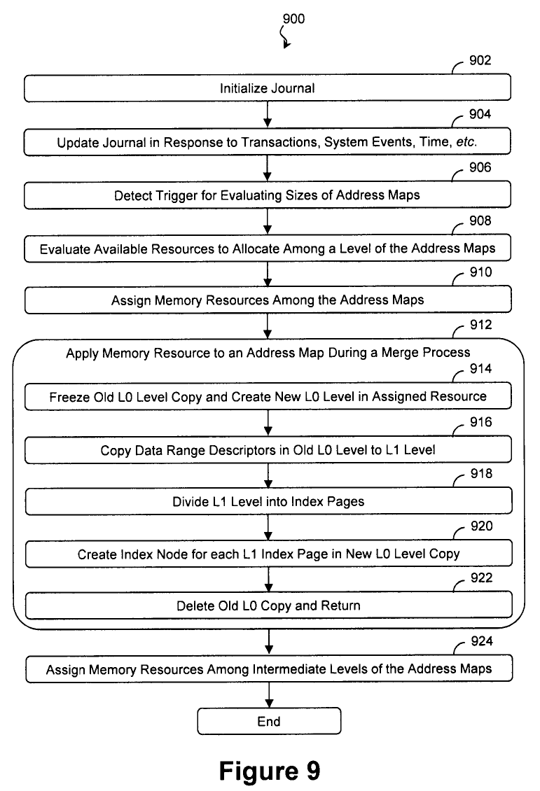

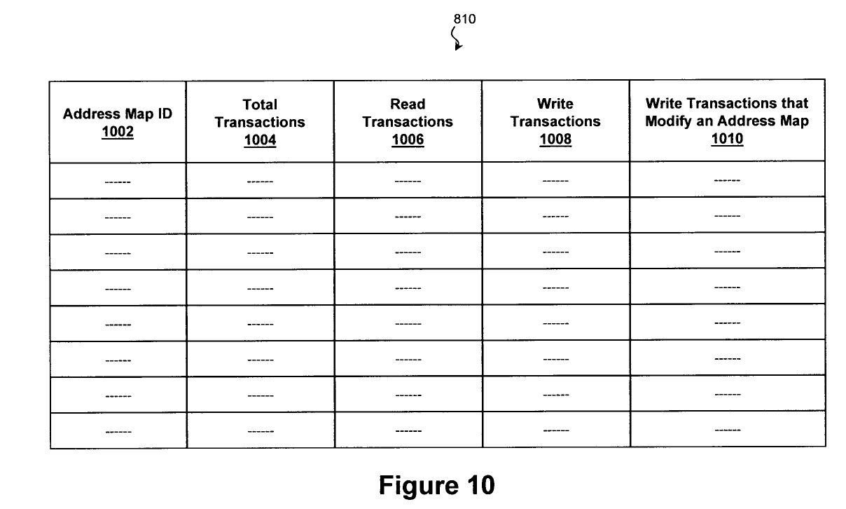

FIG. 8 is a schematic diagram of a data storage architecture 800 according to aspects of the present disclosure. The data storage architecture 800 may be substantially similar to the data storage architecture 100 of FIG. 1. FIG. 9 is a flow diagram of a method 900 of allocating resources among address maps according to aspects of the present disclosure. It is understood that additional steps can be provided before, during, and after the steps of method 900, and that some of the steps described can be replaced or eliminated for other embodiments of the method 900. FIG. 10 is a diagram of a journal 810 according to aspects of the present disclosure.

Referring first to FIG. 8, illustrated is a storage system 102 that is substantially similar to that of FIG. 1. Storage controllers 114 of the storage system 102 utilize an index 802 to translate addresses in a first memory space into addresses in a second memory space. The index 802 may be representative of an LBA-to-Physical Address index 120, or any other suitable index, and may contain one or more address maps arranged as hierarchical trees. In the illustrated embodiments, three address maps are shown and are designated maps 202A, 202B, and 202C.

The levels of the address maps 202A, 202B, and 202C may share common pools of memory. For example, each of the L0 levels 210A, 210B, and 210C are stored within a first pool of memory 804, each of the L1 levels 212A, 212B, and 212C are stored within a second pool of memory 806, and each of the L2 levels 214A, 214B, and 214C are stored within a third pool of memory 808. Because in a typical application, the L0 level of an address map is accessed more frequently than the L1 level, and the L1 level is access more frequently than the L2 level, the first pool of memory 804 may be faster than the second pool of memory 806, and the second pool of memory 806 may be faster than the third pool of memory 808. In an exemplary embodiment, the first pool of memory 804 includes nonvolatile RAM such as battery-backed DRAM that stores each of the L0 levels 210A, 210B, and 210C. In the example, the second pool of memory 806 and the third pool of memory 808 are combined and include one or more SSDs that store each of the L1 levels 212A, 212B, and 212C and each of the L2 levels 214A, 214B, and 214C.

Because the address maps 202A, 202B, and 202C may share memory pools, the present technique may dynamically reallocate memory and other resources among the address maps based on the workload. In some such examples, address maps that currently correspond to a hot spot (an address range experiencing a relatively larger number of transactions) may be made larger, while address maps experiencing a relatively smaller number of transactions may be made smaller. By dynamically resizing the address maps, memory within the memory pools may be reallocated to where it provides the greatest benefit.

For the hot address map that is given a larger L0, its write tax will decrease, and its trapped capacity will increase. Since it is hot (and going through merge cycles more quickly than its peers), its decrease in write tax is advantageous, and its increase in trapped capacity may be a short term (though larger) problem in some instances. For the cold address map given a smaller L0, its write tax per L0 to L1 merge cycle will increase. But since it is cold (and going through merge cycles less frequently than its peers), this increase in write tax is less onerous. Furthermore, the smaller L0 results in less trapped capacity in the cold address map. Since the cold address map is going through relatively few merge cycles, its trapped capacity remains trapped for a longer period of time. Therefore, reductions in trapped capacity in the cold address map may be particularly beneficial in some instances. In this manner, the present technique significantly improves address map management and addresses the problems of inefficiently allocated memory and excessive trapped capacity.

Referring to block 902 of FIG. 9 and referring still to FIG. 8, the storage controller 114 or other computing element of the storage system 102 initializes one or more journals 810 to track incoming data transactions. In the illustrated embodiment, the storage system 102 initializes a single journal 810 that contains separate entries for all of the address maps. However, the journal may be separated, and in some embodiments, the storage system 102 initializes a first journal corresponding to address map 202A, a second journal corresponding to address map 202B, and a third journal corresponding to address map 202C. The journal(s) may track transactions directed to the address spaces of the address maps in order to determine which address maps correspond to hot spots, and may record any suitable transaction data that may be pertinent to such a determination.

An example of a journal 810 suitable for use with this technique is described with reference to FIG. 10. The exemplary journal 810 may record any suitable data that may be relevant to the corresponding address map or maps. In the illustrated embodiments, the journal 810 includes a set of entries, where each entry contains an address map ID 1002 and one or more fields recording amounts of activity associated with the respective address map.

In some embodiments, these fields include field 1004, which records a count of total transactions directed to the address map's address space since a previous point in time. The particular point in time may correspond to a previous event, such as a merge process performed on the corresponding address map. Additionally or in the alternative, the point in time may correspond to a fixed interval of time, and field 1004 may record the number of transaction received/performed in the last minute, hour, or several hours. However, because measuring activity according to wall time may not properly account for periods of system inactivity, in some embodiments, time is measured in terms of disk activity such as read/write/total transactions received, data range descriptors 204 added to an address map 202, or merge events. For example, field 1004 may record the number of transactions received/performed since the last time the L0 level of the corresponding address map was merged and/or resized.

In some embodiments, the fields divide the total transactions into read and write transactions. Exemplary field 1006 records the number of read transaction received/performed since a previous point in time. Likewise, exemplary field 1008 records the number of write transaction received/performed since a previous point in time. In fact, reads and writes may be further subdivided. For example, field 1010 records the number of write transaction that created or modified a data range descriptor 204 since a previous point in time. In various embodiments, other fields may be included in addition to alternatively to fields 1004-1010, such as duration of time for entries, computed write transaction rate, or relative shares of the system's transactions for each address map. Such information may allow the storage controller 114 or other computing element to calculate “hotness” by comparing the rate of write transactions for each of the address maps.

Referring to block 904 of FIG. 9, the storage controller 114 or other computing element of the storage system 102 updates the one or more journals 810 in response to incoming transactions, system events, and/or the passage of time.

Referring to block 906 of FIG. 9, the storage controller 114 or other computing element detects a trigger for evaluating the sizes of the address maps. In some embodiments, the trigger is a merge process performed on any level of any of the address maps. Referring to FIG. 8, the sizes of all of the address maps may evaluated when a merge is performed of any level of address maps 202A, 202B, or 202C. Additionally or in the alternative, the trigger may be based at least in part on: an interval of time, a total count of data transactions received or processed, a system event such as a change in the storage devices 106, and/or any other suitable triggering event.

Upon detecting the trigger, the storage controller 114 or other computing element evaluates the resources available to allocate among the L0 levels of the address maps as shown in block 908 of FIG. 9. For example, the storage controller 114 may consider the total amount of memory in the first pool of memory 804 that contains the L0 levels 210A, 210B, and 210C. In some such examples, the first pool of memory 804 is flexible and can accommodate L0 levels of various sizes. In further examples, the first pool of memory 804 includes discrete memory devices of fixed sizes, each operable to store one L0 level for one address map. While some of these discrete memory devices may be larger than others, each may have a fixed maximum size that will constrain the portion of the address map it stores. In such examples, the first pool of memory may include large devices for larger L0 levels, smaller devices for smaller L0 levels, and intermediate-sized devices for intermediate L0 levels. The storage system 102 may assess the number, sizes, and other qualities of these memory devices when determining which resources to assign to which L0 levels 210. In some embodiments, the storage system 102 determines whether additional resources may be added to the memory pool. For example, memory normally used as a read or write buffer may be reallocated to the first memory pool 804 in order to store an oversized L0 level 210 for a particularly hot data range.

Referring to block 910 of FIG. 9, the storage controller 114 or other computing element assigns memory resources among the L0 levels of the address maps based on the available resources, transaction activity metrics, and/or other factors associated with each of the address maps. In that regard, the storage controller 114 may analyze the entries of the journal 810 to determine any relevant characteristic upon which to base this determination. In some examples, address maps experiencing more data transactions (read, write, or combined) are assigned more memory space for the L0 level 210 than other address maps.

In one of these examples, the storage controller 114 compares an activity metric that tracks one or more types of transactions directed to the address map's address space. The activity metric may track a total quantity, rate, or share of: all transactions, read transactions, write transactions, write transaction that created or modified a data range descriptor 204, or any other suitable category of transactions or activity, such as inserts, modifications, and lookups. The activity metric may track transactions received or processed since a previous point in time. The particular point in time may correspond to a previous event, such as a merge process performed on the corresponding address map. While the point in time may correspond to wall time, time may also be measured in terms of disk activity such as read/write/total transactions received, data range descriptors 204 added to an address map 202, or merge events. The activity metric may also include, e.g., duration of time for entries, computed write transaction rate, or relative shares of the system's transactions for each address map.

Additionally, the memory resources allocated to one level of an address map may depend, in part, on the resources allocated to another level of the address map. For example, an address map with a larger L1 level 212 may be assigned more memory space for the L0 level 210 than other address maps. Furthermore, the memory resources allocated to one address map may depend, in part, on the resources allocated to another address map.

In some embodiments, the storage controller 114 may reassign memory designated for other purposes, such as a read or a write cache, to the first memory pool 804 in order to provide additional resources for the L0 levels. The storage controller 114 may rely on any of the criteria described above when determining whether to add memory resources to the memory pool. For example, the storage controller 114 may reassign additional memory to the memory pool based on a count of transactions since a point in time meeting or exceeding a threshold.

Of course, these examples are not exclusive and are non-limiting, and the resources allocated to an L0 level 210 may depend on any suitable factor. In embodiments where the first pool of memory 804 includes discrete memory devices of various sizes, assigning memory resources may include identifying and selecting a memory device having a predetermined size.

Once the resources have been assigned to address maps, one or more address maps may be moved to the new memory location or resource. Referring to block 912 of FIG. 9, the storage controller 114 or other computing element applies the newly assigned resources while performing a merge process on an L0 level 210 of one of the address maps.

The merge process may be performed substantially as described in blocks 306-314 of FIG. 3. In that regard, referring to block 914 of FIG. 9, the storage controller 114 may freeze the existing L0 level and create a placeholder for a new instance of the L0 level substantially as described in block 306 of FIG. 3. In embodiments where the first pool of memory 804 is fungible, the placeholder is allocated an amount of memory determined in block 910. In embodiments where the first pool of memory 804 includes discrete memory devices of various sizes, the placeholder is created in a memory device identified and selected in block 910.

Referring to block 916 of FIG. 9, the storage controller 114 or other computing element copies the data range descriptors 204 in the existing L0 level into the next lowest level (the L1 level) of the address map substantially as described in block 308 of FIG. 3. Referring to block 918 of FIG. 9, the storage controller 114 or other computing element divides the next lowest level (the L1 level 212) into index pages 208 substantially as described in block 310 of FIG. 3. Referring to block 920 of FIG. 9, the storage controller 114 or other computing element creates an index node 206 for each index page 208 and writes them into the new instance of the L0 level substantially as described in block 312 of FIG. 3. Referring to block 922 of FIG. 9, the storage controller 114 or other computing element completes the merge process by deleting the old L0 level 210 substantially as described in block 314 of FIG. 3.

Referring to block 924 of FIG. 9, the storage controller 114 or other computing element allocates memory resources among the intermediate levels (e.g., L1 levels 212) of the address maps. This may be performed substantially as described in blocks 908-922, and resources may be allocated to the intermediate levels accordingly. Furthermore, it has been determined that an optimal amount of memory for an intermediate hierarchical level of an address map may depend on the amount of memory allocated to other levels of the address map. Accordingly in one example, an amount of memory allocated to an L1 level of an address map is determined to be a geometric mean of (the square root of the product of) the amount of memory allocated to the L0 level and the L2 level of the address map.

In this way, the storage system 102 improves the allocation of memory among the address maps and adapts to changes in the workload over time. This technique specifically addresses the problem with fixed-size address maps and does so efficiently by reallocating memory during the merge process. Accordingly, the present technique provides significant, meaningful, real-world improvements to conventional techniques.

In various embodiments, the technique is performed by using various combinations of dedicated, fixed-function computing elements and programmable computing elements executing software instructions. Accordingly, it is understood that any of the steps of method 300 and method 900 may be implemented by a computing system using corresponding instructions stored on or in a non-transitory machine-readable medium accessible by the processing system. For the purposes of this description, a tangible machine-usable or machine-readable medium can be any apparatus that can store the program for use by or in connection with the instruction execution system, apparatus, or device. The medium may include non-volatile memory including magnetic storage, solid-state storage, optical storage, cache memory, and/or Random Access Memory (RAM).

Thus, the present disclosure provides a method, a computing device, and a non-transitory machine-readable medium for maintaining address maps and for allocating memory between the maps. In some embodiments, the method comprises identifying, by a storage system, a pool of memory resources to allocate among a plurality of address maps. Each of the plurality of address maps includes at least one entry that maps an address in a first address space to an address in a second address space. An activity metric is determined for each of the plurality of address maps, and a portion of the pool of memory is allocated to each of the plurality of address maps based on the respective activity metric. In some such embodiments, the allocating is performed in response to a merge operation being performed on one of the plurality of address maps. In some such embodiments, each of the plurality of address maps is structured as a hierarchical tree and the pool of memory is shared between the top hierarchical levels of the plurality of address maps.

In further embodiments, the non-transitory machine readable medium has stored thereon instructions for performing a method comprising machine executable code. The code, when executed by at least one machine, causes the machine to: evaluate a memory resource to be allocated among a plurality of hierarchical trees. Each of the plurality of hierarchical trees has a first level, and the memory resource is allocated among the first levels of the plurality of hierarchical trees. The code further causes the machine to: allocate a portion of the memory resource to one of the first levels of the plurality of hierarchical trees based on an activity metric associated with the respective hierarchical tree, and during a merge of the one of the first levels of the plurality of hierarchical trees, create an instance of the one of the first levels in the allocated portion of the memory resource. In some such embodiments, the non-transitory machine readable medium comprises further machine executable code which causes the machine to reallocate memory from a cache to the memory resource based on the activity metric.

In yet further embodiments, the computing device comprises a memory containing machine readable medium comprising machine executable code having stored thereon instructions for performing a method of memory management and a processor coupled to the memory. The processor is configured to execute the machine executable code to cause the processor to: evaluate a memory resource to allocate among a plurality of hierarchical trees, wherein each of the hierarchical trees includes a first level, and wherein the memory resource is shared among the first levels of the plurality of hierarchical trees; assign a portion of the memory resource to one of the first levels of the plurality of hierarchical trees based on an activity metric; and create an instance of the one of the first levels in the allocated portion of the memory resource. In some such embodiments, the instance of the one of the first levels is created during a merge of the one of the first levels of the plurality of hierarchical trees. In some such embodiments, the activity metric includes a count of at least one type of transaction selected from the group consisting of: all transactions, read transactions, write transactions, and write transactions that resulted in a change to at least one of the plurality of hierarchical trees.

The foregoing outlines features of several embodiments so that those skilled in the art may better understand the aspects of the present disclosure. Those skilled in the art should appreciate that they may readily use the present disclosure as a basis for designing or modifying other processes and structures for carrying out the same purposes and/or achieving the same advantages of the embodiments introduced herein. Those skilled in the art should also realize that such equivalent constructions do not depart from the spirit and scope of the present disclosure, and that they may make various changes, substitutions, and alterations herein without departing from the spirit and scope of the present disclosure.

What is claimed is:

1. A method comprising:
identifying, by a storage system, a pool of memory resources to allocate among a plurality of address maps, wherein each of the plurality of address maps includes at least one entry that maps an address in a first address space to an address in a second address space;
determining an activity metric for each of the plurality of address maps; and
allocating a portion of the pool of memory to each of the plurality of address maps based on the respective activity metric.

2. The method of claim 1, wherein each of the plurality of address maps is structured as a hierarchical tree having a first hierarchical level and wherein the pool of memory is shared between the first hierarchical levels of the plurality of address maps.

3. The method of claim 2, wherein the allocating of the portion of the memory pool to a first map of the plurality of address maps is performed in response to a merge operation being performed on the first hierarchical level of the first map.

4. The method of claim 3, wherein the merge operation includes copying a data range descriptor from the first hierarchical level of the first map to a second hierarchical level of the first map.

5. The method of claim 3, wherein the merge operation includes creating an instance of the first hierarchical level of the first map within the portion of the pool of memory allocated to the first map.

6. The method of claim 1 further comprising recording the activity metric in a journal in response to an incoming data transaction.

7. The method of claim 1, wherein the activity metric includes a count of at least one type of transaction selected from the group consisting of a total, rate, or share of: all transactions, read transactions, write transactions, inserts, modifications, and lookups.

8. The method of claim 1 further comprising assigning a memory resource to the pool of memory based on the respective activity metric.

9. A non-transitory machine readable medium having stored thereon instructions for performing a method comprising machine executable code, which when executed by at least one machine, causes the machine to:
evaluate a memory resource to be allocated among a plurality of hierarchical trees, wherein each of the plurality of hierarchical trees has a first level, and wherein the memory resource is allocated among the first levels of the plurality of hierarchical trees;
allocate a portion of the memory resource to one of the first levels of the plurality of hierarchical trees based on an activity metric associated with the respective hierarchical tree; and
during a merge of the one of the first levels of the plurality of hierarchical trees, create an instance of the one of the first levels in the allocated portion of the memory resource.

10. The non-transitory machine readable medium of claim 9, wherein the merge of the one of the first levels of the plurality of hierarchical trees includes copying at least one data range descriptor to a second level of the respective hierarchical tree.

11. The non-transitory machine readable medium of claim 9, wherein the memory resource is configured to be shared between the first levels of the plurality of hierarchical trees.

12. The non-transitory machine readable medium of claim 9 comprising further machine executable code which causes the machine to reallocate memory to the memory resource based on the activity metric.

13. The non-transitory machine readable medium of claim 12, wherein the reallocated memory is reallocated from a cache.

14. The non-transitory machine readable medium of claim 9, wherein the memory resource is a first memory resource, and wherein each of the plurality of trees has a second level, the medium comprising further machine executable code which causes the machine to:
allocate a portion of a second memory resource to one of the second levels of the plurality of hierarchical trees; and
during a merge of one of the second levels of the plurality of hierarchical trees, creating an instance of the one of the second levels in the allocated portion of the second memory resource.

15. The non-transitory machine readable medium of claim 14, wherein each of the plurality of trees has a third level, and wherein the allocating of the portion of the second memory resource allocates a memory size to the one of the second levels that is a geometric mean of the first level and the third level of the respective hierarchical tree.

16. The non-transitory machine readable medium of claim 9, wherein the activity metric includes a count of at least one type of transaction selected from the group consisting of: all transactions, read transactions, write transactions, modifications, inserts, and lookups.

17. A computing device comprising:
a memory containing machine readable medium comprising machine executable code having stored thereon instructions for performing a method of memory management; and
a processor coupled to the memory, the processor configured to execute the machine executable code to cause the processor to:
evaluate a memory resource to allocate among a plurality of hierarchical trees, wherein each of the hierarchical trees includes a first level, and wherein the memory resource is shared among the first levels of the plurality of hierarchical trees;
assign a portion of the memory resource to one of the first levels of the plurality of hierarchical trees based on an activity metric; and
create an instance of the one of the first levels in the allocated portion of the memory resource.

18. The computing device of claim 17, wherein the instance of the one of the first levels is created during a merge of the one of the first levels of the plurality of hierarchical trees.

19. The computing device of claim 18, wherein the merge includes copying a data range descriptor from the one of the first levels to a second level of the respective hierarchical tree.

20. The computing device of claim 17, wherein the activity metric includes a count of at least one type of transaction selected from the group consisting of: all transactions, read transactions, write transactions, modifications, inserts, and lookups.
